(19) United States
(12) Patent Application Publication
(10) Pub. No.: US 2017/0262766 A1
(43) Pub. Date: Sep. 14, 2017

(54) VARIABLE GROUPING FOR ENTITY ANALYSIS

(71) Applicant: LinkedIn Corporation, Mountain View, CA (US)

(72) Inventors: Chung-Ting John Chao, San Mateo, CA (US); Wei Di, Cupertino, CA (US); Michael A. Davis, Santa Clara, CA (US); Xing Zhou, Mountain View, CA (US); Yan Liu, Sunnyvale, CA (US)

(21) Appl. No.: 15/063,814

(22) Filed: Mar. 8, 2016

(51) Int. Cl. G06N 99/00; G06N 5/04; G06F 17/12

(52) U.S. Cl. CPC G06N 99/005; G06F 17/12; G06N 5/04

(57) ABSTRACT

Techniques and a system are provided for a variable analysis system that learns from input variables. The variable analysis system may be used to determine how variables relate to other variables, to develop a tool used to predict outcomes for an entity based on other entities. The variable analysis system may employ grouping, so that multiple variables are considered as one input in a given model.

### TECHNICAL FIELD

The present disclosure relates to artificial intelligence to recognize and classify input data about entities and, more particularly, to methods and systems for receiving variables and determining what and how to use groups to draw conclusions about entities. SUGGESTED GROUP ART UNIT: 2161; SUGGESTED CLASSIFICATION: 706/12.

### BACKGROUND

Computers allow humans access to data in large quantities, with greater ease than before. However, the large quantities of data outstrips our ability to make sense of and use the data.

As one example, it is possible to gather data on different entities and oftentimes, each entity will contain many different data points (or variables) that relate to the entities' spending. The spending may be any form of spending, such as advertisement spending, payroll, capital expenditures, and many other types of spending. Although each variable may have predictive value or a weight that determines its strength in relation to the entities' spending, this weight is not readily apparent from the variable itself. For example, a specific company may have different data points, such as what industry the company is in and how many people at the company have technical backgrounds. The company's industry may have bearing on how much it will spend on advertisement online. The number of people at the company whom have technical backgrounds may also play a role in how much it will spend on advertisement online. But this information is generally of low value until it is properly placed in the context of exactly what the weight of each respective variable is, especially when compared to other variables. We may know that companies in the technology sector will be more likely to advertise using the Internet, but it is impossible to know the strength of this variable, when compared to other variables (e.g., the number of people with technical backgrounds). Additionally, the sheer number of variables for an entity makes it hard to interpret cause and effect relationships between variables and spending amounts.

Machine learning algorithms may be used to understand cause and effect relationships between variables and spending amounts. However, machine learning algorithms may create a black-box situation, where the machine learning algorithms are provided input (e.g., variables and spending information), which leads to a corresponding output. These machine learning algorithms do not specify how these outputs are related to each of their inputs, making it difficult to interpret the output.

For example, a machine learning algorithm may be used to estimate an amount of possible spending for a company in the coming year given the company's past spending information and variable information. A Random Forest algorithm may be used to build a predictive model, based on the information. However, the Random Forest algorithm will not be able to provide information on how each variable affects the output. It would not be able to, for example, show how increasing variable A would affect the output.

Therefore, there is a need to be able to understand and interpret large sets of data, when there are many variables present.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a modeling system, according to an embodiment.

FIG. 2 shows an example of a model, in an embodiment.

FIG. 3 is a flowchart that depicts an example process creating models.

FIG. 4 is a flowchart that depicts an example process applying models.

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A variable analysis system is described herein which implements techniques for determining how each data point or variable for an entity relates to a predicted level of spending. The variable analysis system determines how each variable relate to other variables, using a dataset with information on more than one company. For example, a dataset used by the variable analysis system includes information on at least two companies, organized as a set of variables, which define different data points of the companies.

The variable analysis system may be used as part of a modeling system. The modeling system is used to group similar variables. Grouped variables and non-grouped variables are combined to create a model, with the assumption that the grouped variables and non-grouped variables when put together conform to mathematical modeling principles, such as linear regression. For example, a model may include at least one grouped variable and an additional non-grouped variable. Grouped variables themselves may also conform to linear regression principles within the group. This assists in simplifying the model, as well as avoid various drawbacks when applying linear regression principles to data. By simplifying the model, variables become interpretable, rather than having a large number of variables where relationships are hidden.

The variable analysis system may employ an algorithm to create and use models to produce a predicted value with the following characteristics:

(1) Able to determine how changes to input variables will affect an output result determined by the model. For example, not only is a weight for variables determined, but exactly how changing weights for one or more variable will affect the predicted value.

(2) Produce models that include relationships for variables that may not be linear. For example, sometimes a linear model is not sufficient for dealing with variables with a non-linear relationship. The variable analysis system may build a complex hierarchy structure that, for each respective part, may employ a simple linear type of modeling. However, when the complex hierarchy structure is combined to produce a model, non-linear relationships are transformed so that they may be represented as a linear model in the model.

### Example Modeling System

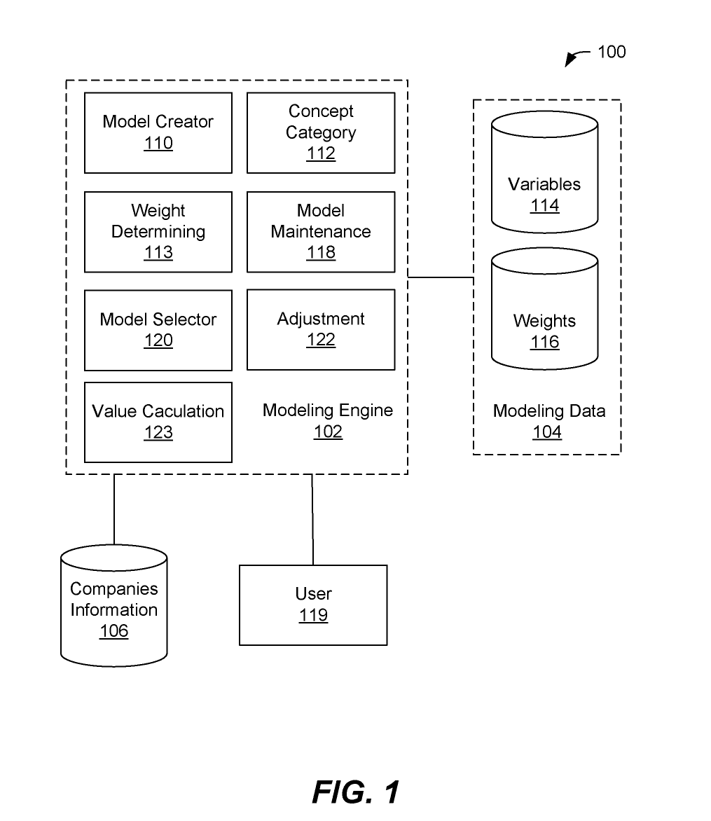

FIG. 1 illustrates a modeling system 100 in which the techniques described may be practiced according to certain embodiments. The modeling system 100 is a computer-based system. The various components of the modeling system 100 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. The descriptions of the components may be converted into software code, including code executable by an electronic processor. The modeling system 100 illustrates only one of many possible arrangements of components configured to perform the functionality described herein. Other arrangements may include fewer or different components, and the division of work between the components may vary depending on the arrangement.

The modeling system 100 includes various components used to create and use models. For ease of understanding, some of these components are separated into different component groups: a modeling engine component group 102 and a modeling data component group 104. Each component group may have one or more additional components as part of the group. However, alternate embodiments of the modeling system 100 may include more or fewer components in each component group, as well as component groupings different than the one shown in FIG. 1.

The modeling engine 102 may use various mathematical principles to determine the relationship of different variables to a given outcome. In an embodiment, the modeling engine 102 uses linear regression or linear modeling techniques. As is discussed in greater detail elsewhere, this means that, to create a model and any associated sub-models, input to these models are assumed to take a linear relationship.

A company information data source 106 includes company information for the modeling engine 102. The company information data source 106 includes information on various companies (or organizations), which information the modeling system 100 uses to create models. Each company in the company information data source 106 includes two or more variables (e.g., information on different aspects of the respective company) and their associated value. The modeling engine 102 includes a model creator component 110 responsible for creating models based on the data from the company information data source 106. A concept category component 112 is responsible for determining whether variables are directed towards the same concept. For example, the concept category is based on a business meaning of the variables. Some examples of business meanings include engagement with a service of members in a company, usage of a service by the company, and other meanings. A weight determining component 113 is responsible for determining a weight for each group and variable included within a model. For example, the model creator component 110 receives grouped variable information (e.g., variables determined by the concept category component 112 as being directed to the same concept) and determines weights for each variable and grouped variable (e.g., by the weight determining component 113). This information is stored by the model creator component 110 as a model, which may be used to make predictions about companies different than those companies used to create the model.

The models are stored in the modeling data component group 104. A variables data store 114 and a weights data store 116 each store the different types of variables and their weights, respectively. In another embodiment, the variables and weights of a model are not stored separately, but are stored in the same data source.

The modeling engine 102 includes a model maintenance component 118. Particularly when there is new company data in the company information data source 106, models may be updated to reflect the latest information. Updating generally occurs yearly, but may occur at any other given time interval (e.g., quarterly, biannually, or other).

In an embodiment, the modeling system 100 also provides features to allow users to use stored models to predict spending for other entities. A model selector component 120 is responsible for, after receiving entity information from a user 119, selecting a model that may be used to predict information about the received entity. The user 119 may be presented with weights for each variable for the received entity. The user 119 may provide, to an adjustment component 122, changes to the weights, based on human inferences about the weights. For example, if a user believes a variable is given too high of a weight, the user may manually decrease the weight. Generally, the user will not be able to see purely from the numerical value of the weight (e.g., scale on 0-1, 0-10, 0-100, or any other scale) whether a variable is given too high or low of a weight. However, since the modeling engine 102 provides a listing of variables and their weights, the user is able to determine a weight as being too high or low by comparing weights of one variable to another. Manually changing the weight causes the modeling engine 102 to recalculate the predicted level of spending, based on the newly received weights.

A value calculation component 123 is responsible for determining values for variables. The value calculation component 123 retrieves, for one or more variables for a company, corresponding values for the variables. The value calculation component 123 may be used when generating models in the modeling system 100 or when using models in the modeling system 100. Depending on what value is retrieved by the value calculation component, there may be different steps taken by the value calculation component 123, before the retrieved value is usable to create a model or use in a model:

Valid. A retrieved value is directly usable in the model.

Valid but scaled. A retrieved value may be usable, but not directly usable in the model. For example, a variable may be a scaled variable. These variables have an actual associated value or amount but, because using the amount directly would skew modeling, the associated amount is scaled. For example, if the variable represents a dollar amount, the dollar amount itself cannot be used to create a model. This is because the dollar amount may be very high, which if directly entered to create a model, will give the variable outsized importance. In these cases, the variable is scaled. The scale may be a 0-1 scale, 0-100 scale, or any other scale.

Invalid. A retrieved value indicates a null or other unusable result. This will occur when the value information for a variable does not exist in a dataset. The modeling system 100 may determine what type of variable the undefined variable is before determining what value to return. Some different types of variables include:

(1) Binary. For example, some variables may be binary variables. In other words, these variables may be only one of two values, either 0 or 1. Some examples of these are variables representing whether something exists (e.g., whether a company is part of a particular industry, or other types of variables). In this case, the modeling system may impute a value to the variable, either a 0 or 1.

(2) Numeric. In another example, some variables may be a numeric value. For example, a variable for “company age” may not be defined in a dataset for a company. In this case, the value calculation component 123 will compute an average age of other similar companies to be used. As another example, the value calculation component 123 may also assign a variable's value as an arbitrary “0.”

(3) Categorical. Variables may also represent categories. For categorical variables, the value calculation component 123 may create an additional category called ‘unknown’ to stand for that the original is missing. For example, if industry information for a company is missing, and the modeling system 100 includes categories of industry type ind-a, ind-b, ind-c, then the value calculation component 123 may assign a new category with ind-unknown.

### Linear Modeling

In an embodiment, models and sub-models of the modeling system 100 employs linear modeling techniques. Linear modeling techniques allow multiple variables to be considered, when predicting a certain outcome. Further, linear modeling techniques allow variables to be easily interpreted, since coefficient estimated directly amounts to the importance of each feature towards the final results.

For example, the modeling system 100 uses entity information including variables and a level of spending to create a model. With this information, the modeling system 100 determines the respective weight for each variable. This is stored as a model that may then be applied towards other entities to make predictions. For example, the model may conform to the following equation:

ŷ=β₀+β+β₁x₁+β₂x₂+β₃x₃+ . . .

The goal (or Objective Function) of the above equation is to:

minimize Σ(y−ŷ)²

subject to Σᵢ₌₁^{t}βᵢ≦s

In an embodiment where the modeling system is used to determine an estimation of spending for an entity (or total market opportunity), y represents a size of prize, ŷ represents an estimation for a size of prize, s represents a tuning parameter that determines how sparse a produced model is, β₀ represents an initial bias of the size of prize, β₁ represents a value for a first variable, x₁ represents a weight for the first variable or the scores generated by the group model, and so on. The objective function is used to minimize the difference between an actual size of prize (y) and an estimated size of prize (ŷ). This is subject to the tuning parameter (s), which controls how many variables are included in a generated model. This controls the complexity of the generated model, in terms of how many variables the model may receive as input. As an example, the tuning parameter may be used to remove variables from the model that are equal to 0 (or have no value to the model) or variables that are dependent on other variables in the model (e.g., variables that are considered in the model as a group). The model may be created using information from multiple companies. Generally, when producing models, the modeling system 100 has available data on the values for y and β, and is required to solve for x (e.g., the weight for each variable).

However, using linear modeling techniques may have drawbacks. For one thing, applying a linear model to variables assumes that the variables used to produce the model are independent. However, in real-life some variables are correlated on each other. In other words, they relate to a similar concept, and thus share dependencies where one variable is linked to another in a direct or indirect relationship (e.g., going up or down in one variable means the other variable moves in the same or opposite direction). The modeling system 100 uses additional sub-models or groups to accommodate this situation.

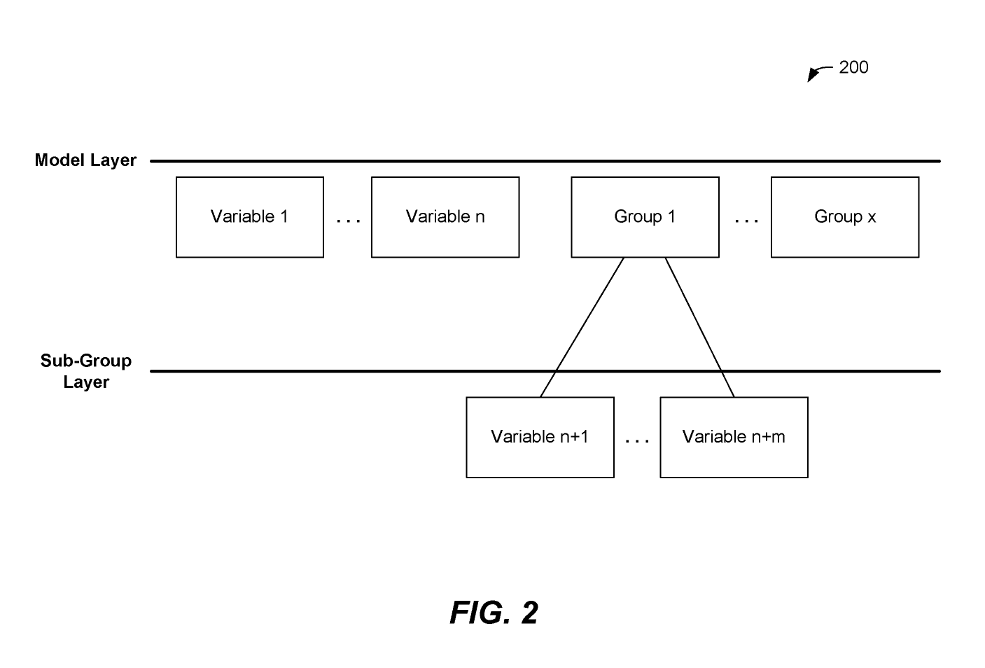

FIG. 2 shows an example of a model 200, in an embodiment. In this example, the model 200 is divided into two layers: a model layer and a sub-group layer. The model layer includes all input directly usable in the model. For example, this includes input for variable 1 to variable n and for group 1 to group x, where n and x are integers. The sub-group layer includes variables that are input used by groups. For example, group 1 includes variables n+1 to n+m, where m is an integer. Additional groups would likewise include variables as input defined in the sub-group layer.

In this example, the model layer and each group defined in the sub-group layer include input that may be represented as linear relationships in the model layer and each respective group. For example, the input for the model layer may be represented as a linear relationship. Additionally, the input for the group 1 may be represented as a linear relationship.

In an embodiment, a model may include any number of variables and sub-groups. For example, there may be hundreds or even thousands of variables that may be considered in the model. Each group of the model may also include tens or hundreds of variables, each group including its own respective variables. Groups may include different numbers of variables. For example, while a first group may include four variables, another group may include five variables.

When creating each group, the variables selected for each group are strategically selected. For example, one group may contain variables directed towards engagement information, and within the group there may exist correlations between the variables. After applying a sparse linear model, such correlation can be treated in the group to make sure that such correlation will not impact the final model. In an embodiment, the modeling system 100 uses a model that includes at least one sub-model and one variable. In an alternate embodiment, the modeling system 100 uses a model that includes at least two sub-models.

### Example Embodiment for Determining Spending Size

In an embodiment, the modeling system 100 is a system for determining a spending size (or size of prize) for an entity. The size of prize is an estimation of maximum spending a company will put towards services with another company. For example, the size of prize may be an estimation of how much a company may spend on a target service. The modeling system 100 provides an estimate based on the number of variables considered as well as detecting and modeling for meaningful relationships between the variables (e.g., using groups).

There may be a variety of reasons why a company's actual spending and their estimated spending are different. For example, a company may be using a competing service, which splits their spending with the target service. The company may also simply be spending less than their peers, because they have not realized the maximum gains by spending more with the target service.

There are many reasons why this estimation of spending may be helpful. For example, this information may be used to estimate, based on the difference between a company's actual spending and their estimated spending, how much more the company may spend. Alternatively, this information may be used to prioritize, understand, or assign persons to work on a company account. If a size of prize is higher, then it may be worthwhile to devote more resources to capture as much of their spending as possible.

In an embodiment, the modeling system 100 receives a dataset to create a model to determine an estimation of spending (or size of prize) for companies similar to those in the dataset. The dataset includes information on entities, such as companies and organizations, as well as their associated spending information. Each company or organization includes variables, which represent a different piece of data from the respective company. Variables may have a direct or indirect relationship on the estimation of spending. If a variable is correlated with another variable, the variables will be placed into a group, and the output from the group may then be directly used for the final model. Some variables may not be correlated with the estimation of spending for a company and these variables are removed from consideration when generating the model. Some examples of variables that may be used in various embodiments of the modeling system are included with Table 1 below.

TABLE 1
Example of Variables for a Company

| Variable Name | Description |
|---|---|
| cfg_var.group.engagement | Represents a grouping of variables, indicating engagement of |
| | persons associated with the company that use a social |
| | networking service. For example, variables in this group |
| | describe how individual members from a company uses the |
| | social networking service (e.g., click, posts, comments, |
| | impressions, shares) and other derived data based on these |
| | features. |
| cfg_var.group.usage | Represents a grouping of variables, indicating usage of |
| | persons associated with the company that use a social |
| | networking service. For example, variables in this group |
| | describe how a company interacts with the social networking |
| | service (e.g., a number of sponsored jobs, number of |
| | marketing jobs, frequency of company page updates) and |
| | other derived data based on these features. |
| cfg_var.group.onlinespending | Represents a grouping of variables, indicating online spending |
| | of persons associated with the company. |
| cms_score | Represents a Content Marketing Score. This score represents a |
| | marketing activities index to: |
| | Quantify and benchmark the influence companies have on a |
| | social networking service through content marketing |
| | Provide clients with a compelling understanding of how they |
| | stack up against their peers |
| | Help clients improve their content marketing engagement |
| company_type | Represents a type of the company. |
| industry | Represents an industry of the company. |
| is_num_marketers | Represents a number of marketers associated with the |
| | company. |
| is_num_non_emp_follower | Represents a number of non-employee followers of the |
| | company on a social networking site. The more non-employee |
| | followers means the company has greater influence on the |
| | social networking site. |
| w_skills | Represents a number of employees with the company that |
| | have a specific skill. |

When developing models, the modeling system 100 determines that some variables are directed towards a concept category. For example, the first and second variables are directed towards a first concept category. The modeling system 100 may use a variety of methods to determine whether a variable is directed towards a concept category. In an embodiment, the modeling system 100 includes a concept category table that defines the relationship of variables in a dataset and which, if any, sub-model a particular variable should belong to. Not every dataset may include variables for every sub-model defined in the table.

In an embodiment, the modeling system 100 includes a concept category table created by a human operator. When determining whether variables are directed to any of the sub-models of the concept category table, the human operator may add or remove variables from a given concept category and the modeling system 100 recalculates prediction information for the human operator, based on their changes. If the human operator believes that their changes appropriately affect the prediction information, the human operator may apply the changes and update the concept category table.

In an alternate embodiment, the modeling system 100 provides an automated method to determine whether variables are directed to the same concept category. The modeling system 100 includes statistical algorithms to determine whether one or more variables are highly correlated. For example, the modeling system 100 may test different groupings of variables to determine test prediction information. If variables are highly correlated during this test, the modeling system 100 updates the concept category table accordingly.

The first concept category has a relationship to the size of prize. For example, the first concept category may be the business purpose of user engagement with a social networking service. Some examples of different concept categories include general online spending, usage of a service by persons associated with the entity (e.g., employees, followers, or other associated), engagement with a service, or other.

A first sub-model is created, based on the first and second variables, where the first sub-model specifies a relative strength of the first and second variables to the first concept category. The modeling system 100 receives information that the first and second variables are not to be used in the model directly. For example, the first and second variables may be represented as a linear model (e.g. the first sub-model). When a result for the first sub-model is calculated, the result may be entered as input to the model.

The modeling system 100 determines that a third variable represents a variable that is directed towards a second concept category. For example, the third variable is a variable that is not directed to the first concept category (e.g., the third variable and the first sub-model affect the estimation of spending independently from each other). When using the model, the model does not directly accept the first or second variables as input, but accepts the third variable. This means that, while the first and second variables affect determining a size of prize, their affect is indirect, by virtue of their inclusion with the first sub-model.

The modeling system 100 creates the model, based on the first sub-model and the third variable. The model may be applied to companies not used to create the model to determine an estimation of its respective size of prize.

The modeling system 100 may create multiple models used to estimate the size of prize for companies or organizations with different characteristics. For example, while some companies in the dataset are used to create a first model, other companies may be used to create a second model, and so forth. However, a company's data may be limited to creating only one model. In other words, a company may be used to create a first model, but no other models will be based off the company.

There may be different reasons as to why a company is used to create one model as opposed to other models. Generally, companies that share certain similarities will be classified as data for the same model. For example, although the dataset includes multiple variables, not all companies included in the dataset will have each of the variables defined. Some companies will have incomplete data. Companies that have a similar level of completeness in their data may be used to generate a model. As another example, models may be based on the geographic region or location of the companies. This may mean that, for geographic markets that are penetrated by the target service, companies within the same geographic market may be used to produce a model.

Some examples of models generated in an embodiment of the modeling system 100 are included with Table 2 below.

TABLE 2
Example of Different Models

| Model | | Geographic | Penetrated | Model With or Without |
|---|---|---|---|---|
| Identifier | Company ID | Region | Market | Spending |
| 0.0, 0.1 | With Company | Region_1 | In Market | (.0) without spend/(.1) with |
| | ID | | | spend |
| 1.0, 1.1 | With Company | Region_2 | In Market | (.0) without spend/(.1) with |
| | ID | | | spend |
| 2.0, 2.1 | With Company | Region_3 | Out Market | (.0) without spend/(.1) with |
| | ID | | | spend |
| 3.0, 3.1 | With Company | Region_Unknown | Out Market | (.0) without spend/(.1) with |
| | ID | | | spend |
| 4.0, 4.1 | No Company ID | Region_All/ | All/ | (.0) without spend/(.1) with |
| | | Region_Unknown | Unknown | spend |

In the example of different models shown in Table 2, there are a total of ten different models. Each model may specify a particular geographic region the model is used for. For example, Region_1 may include North America, while Region_2 and Region_3 may include geographic regions other than those in North America. Other regions include Region_Unknown and Region_All. In general, the more accurate a company's region is, the more accurate of a model that may be selected when applying the model.

For example, a model is determined with spending information and without spending information. When determining a size of prize, having access to spending information will make predictions more accurate. However, there may only be limited amounts of this information available. For example, it may not be possible to obtain for business, legal, confidentiality, or other reasons previous spending information. Since this may disqualify a potential valuable set of information (e.g., companies without spending information), the modeling system 100 may develop both models with and without spending information. In an embodiment, when a model with spending information and a model without spending information are used, the model that produces a higher size of prize is selected.

A model is also determined using information regarding what geographic region or market a company is in. This information may be available from a variety of sources, such as a company Web page, third-party data, and employee locations, in that order. The model notes which markets are penetrated markets.

The models may include companies with missing information, identified as models 4.0 and 4.1 in Table 2. Some companies in the dataset do not have complete data, and when a company is associated with less than ten-percent of data necessary to build a model based on the company, the size of prize cannot be predicted and the size of prize is defined to be 0.

### Example Flow for Generating Models

Some specific flows for implementing a technique of an embodiment are presented below, but it should be understood that embodiments are not limited to the specific flows and steps presented. A flow of another embodiment may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular application or based on the data.

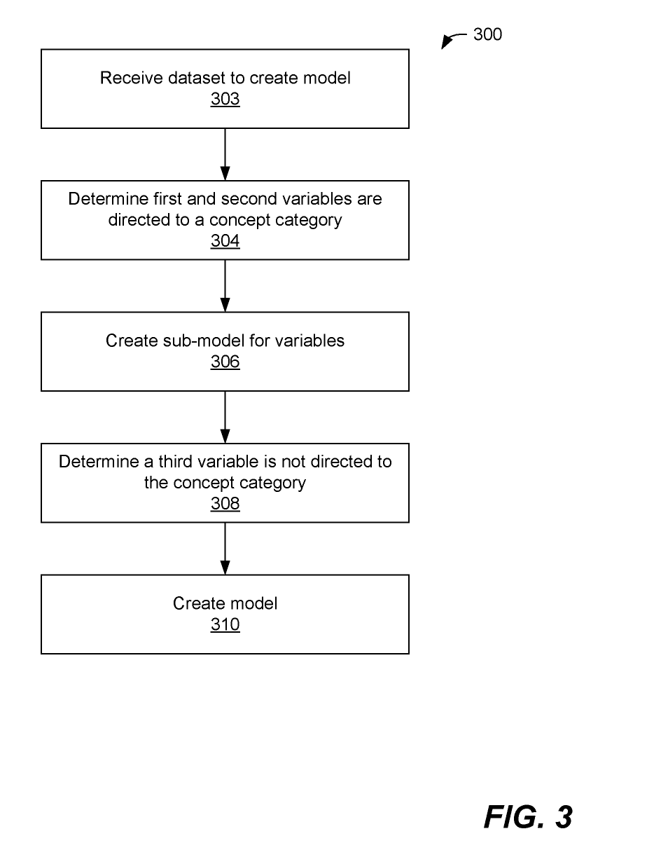

FIG. 3 is a flowchart that depicts an example process 300 for creating models, in an embodiment. These models may be used to predict results in a variety of categories, such as a size of prize, an overall spending, a capital expenditure, or any other type of prediction, based on data with many variables. In a step 303, the modeling system 100 receives a dataset from which to create one or more models. The dataset may be a composite dataset, taken from one or more data sources. For example, the dataset may include data from different companies or organizations, but sometimes also different data sources within a single company or organization.

In a step 304, the modeling system 100 determines first and second variables are directed to a concept category. In a step 306, the modeling system 100 creates a sub-model for variables directed to the same concept category. When the first and second variables are directed to the same concept category, this means that the first and second variables are not directly used by the final model. Instead, first and second variables are grouped together, and a sub-model is generated for the first and second variables. The sub-model in turn, is included with a finalized model. In other implementations, there may be more than two variables directed to the same concept category. For example, there may be three, four, five, or more variables directed to the same concept category.

In a step 308, the modeling system 100 determines a third variable is not directed to the concept category. In a step 310, the modeling system 100 creates a final model. The final model may be based on linear regression principles and includes the sub-model and third variables as inputs.

### Example Flow for Using Models

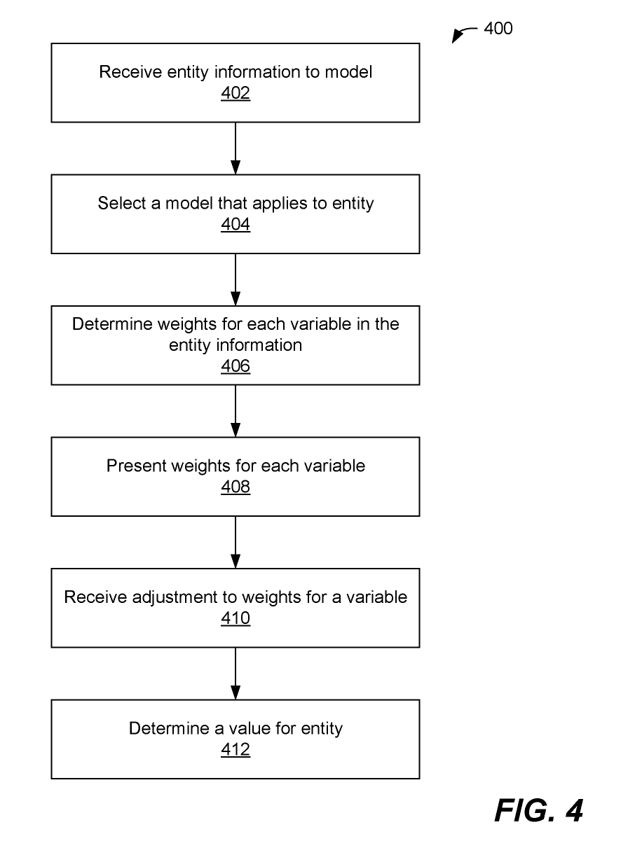

FIG. 4 is a flowchart that depicts an example process 400 for applying models, in an embodiment. These models may be models used in determining a size of prize, estimation of spending, or any other context. In a step 402, the modeling system 100 receives entity information to model. For example, this may be company information. The company information may include various variables as well as their associated values for the variables. In a step 404, the modeling system 100 selects a model, from among multiple models, that applies to the received entity. In an embodiment, a model applies to the received entity when it shares a geographic region of companies used to create the model. In alternate embodiments, a model applies to the received entity when it shares a similar level of completeness in data.

In a step 406, the modeling system 100 determines weights for each variable of the received entity. For example, the selected model includes various weights for variables. In an optional step 408, the modeling system 100 presents weights for each variable. For example, the weights as determined in the step 406 are presented to a user on a graphical user interface, so that the user may tell what weights are associated with which variable.

In a step 410, the modeling system 100 receives adjustments to the weights. This is an optional step, when the user determines the weights could use adjustment. For example, via the user interface, the user increases or decreases the weight for a variable. The user may change the weights for more than one variable. In a step 412, the modeling system 100 determines a value for the received entity, based on the received entity's information, the model information, and the adjusted weights.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

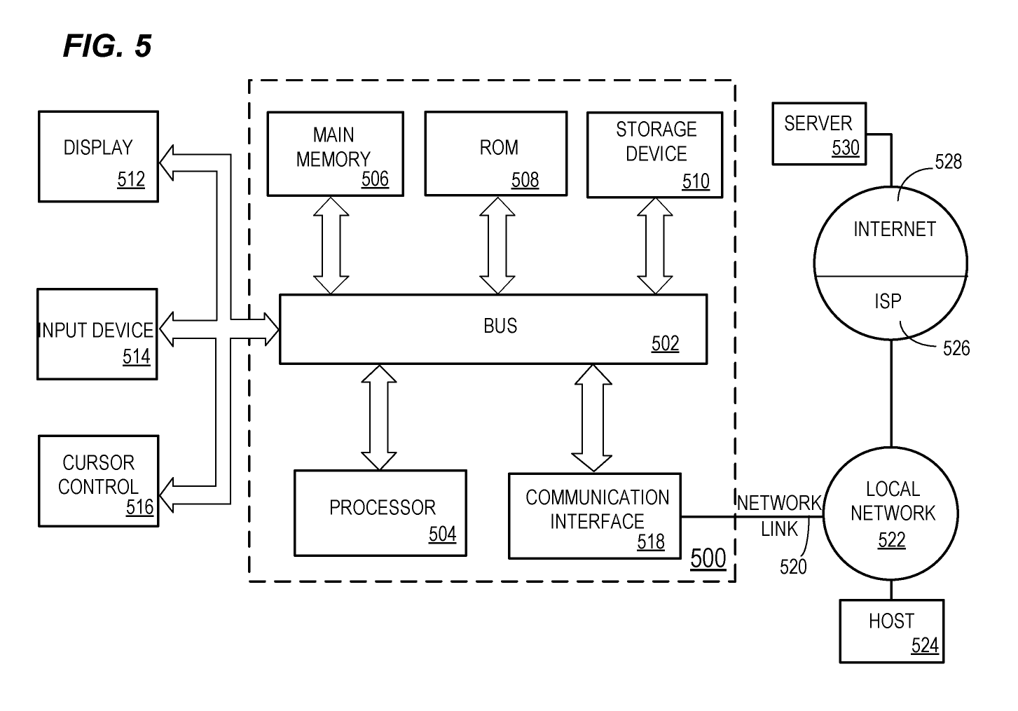

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that include bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a dataset from which to create a model, wherein the dataset comprises information on a plurality of entities and the information is arranged according to a plurality of variables that includes a first variable, a second variable, and a third variable;
determining that the first variable and the second variable represent variables that are directed towards a first concept category;
creating, based on the first variable and the second variable, a first sub-model that specifies a first relative strength of the first variable and the second variable to the first concept category;
determining that the third variable represents a variable that is directed towards a second concept category that is different than the first concept category; and
creating the model based on the first sub-model and the third variable, wherein the model specifies a second relative strength of the first sub-model as compared to the third variable,
wherein the method is performed by one or more computing devices.

2. The method of claim 1 further comprising:
selecting, to include for the model, first data, from the dataset, on a first entity and a second entity; and
selecting, to include for another model, second data, from the dataset, on a third entity and a fourth entity, wherein the model excludes data from the third entity and the fourth entity and the other model excludes data from the first entity and the second entity.

3. The method of claim 2 wherein selecting the first data for the model comprises selecting the first data for the model based at least in part on a level of completeness of data from the first entity and the second entity as compared to the third entity and the fourth entity.

4. The method of claim 2 wherein selecting the first data for the model comprises selecting the first data for the model based at least in part on a geographic location of the first entity and the second entity as compared to the third entity and the fourth entity.

5. The method of claim 1 wherein the first variable and the second variable are provided as input to produce the first sub-model and the first sub-model is provided to produce the model.

6. The method of claim 1 wherein the third variable comprises an indirectly proportional relationship to the first sub-model.

7. The method of claim 1 wherein the third variable comprises a directly proportional relationship to the first sub-model.

8. The method of claim 1 wherein the dataset comprises:
a plurality of entity identifiers representing a plurality of entities,
for each entity represented by the plurality of entity identifiers including:
spending information,
a plurality of variables and, for at least three of the variables, an associated value; and
the method further comprises determining that, for each entity represented by the plurality of entity identifiers, the plurality of variables are directed towards spending information.

9. The method of claim 1 wherein the first variable and the second variable are interdependent variables.

10. The method of claim 1 wherein the first variable and the second variable are directed towards a level of engagement with a Website.

11. The method of claim 1 wherein the first variable and the second variable are directed towards a level of online spending.

12. The method of claim 1 wherein the model and first sub-model comprise a linear model.

13. The method of claim 1 further comprising before determining that first variable and the second variable are directed towards the first concept category, determining, from the dataset, that values for the first variable, the second variable, and the third variable are defined for the first entity and the second entity of the plurality of entities.

14. The method of claim 1 further comprising using the model to make a prediction for a selected entity that is not included in the plurality of entities.

15. The method of claim 1 further comprising:
determining the information arranged according to a plurality of variables further includes a fourth variable and a fifth variable;
determining that the fourth variable and the fifth variables represent variables that are directed towards a third concept category that is different than the first concept category and the second concept category; and
creating, based on the fourth variable and the fifth variable, a second sub-model that specifies a relative strength of the fourth variable and the fifth variable to the third concept category,
wherein the step of creating the model is further based on the second sub-model and the model specifies a third relative strength of the first sub-model and the second sub-model and the third variable to a predicted level of spending.

16. The method of claim 1 wherein the second relative strength specified in the model comprises a relative strength of the first sub-model as compared to the third variable separate from other variables of the information provided by the dataset.

17. The method of claim 1 further comprising:
determining that a fourth variable represents a variable that is directed towards the second concept category; and
creating, based on the third variable and the fourth variable, a second sub-model that specifies a third relative strength of the third variable and the fourth variable to the second concept category;
wherein the second relative strength comprises a relative strength of the first sub-model as compared to the second sub-model.

18. A system comprising:
one or more processors;
one or more computer-readable media carrying instructions which, when executed by the one or more processors, cause:
receiving a dataset from which to create a model, wherein the dataset comprises information on a plurality of entities and the information is arranged according to a plurality of variables that includes a first variable, a second variable, and a third variable;
determining that the first variable and the second variable represent variables that are directed towards a first concept category;
creating, based on the first variable and the second variable, a first sub-model that specifies a first relative strength of the first variable and the second variable to the first concept category;
determining that the third variable represents a variable that is directed towards a second concept category that is different than the first concept category; and
creating the model based on the first sub-model and the third variable, wherein the model specifies a second relative strength of the first sub-model as compared to the third variable.

19. The system of claim 18 wherein the one or more computer-readable media carrying instructions which, when executed by the one or more processors, further cause:
selecting, to include for the model, first data, from the dataset, on a first entity and a second entity; and
selecting, to include for another model, second data, from the dataset, on a third entity and a fourth entity, wherein the model excludes data from the third entity and the fourth entity and the other model excludes data from the first entity and the second entity.

20. The system of claim 19 wherein selecting the first data for the model comprises selecting the first data for the model based at least in part on a level of completeness of data from the first entity and the second entity as compared to the third entity and the fourth entity.

21. One or more storage media storing instructions which, when executed by one or more processors, cause:
receiving a dataset from which to create a model, wherein the dataset comprises information on a plurality of entities and the information is arranged according to a plurality of variables that includes a first variable, a second variable, and a third variable;
determining that the first variable and the second variable represent variables that are directed towards a first concept category;
creating, based on the first variable and the second variable, a first sub-model that specifies a first relative strength of the first variable and the second variable to the first concept category;
determining that the third variable represents a variable that is directed towards a second concept category that is different than the first concept category; and
creating the model based on the first sub-model and the third variable, wherein the model specifies a second relative strength of the first sub-model as compared to the third variable.

22. The one or more storage media of claim 21, wherein the first and second variables are provided as input to produce the first sub-model and the first sub-model is provided to produce the model.
